(19) United States
(12) Patent Application Publication
(10) Pub. No.: US 2003/0031624 A1
(43) Pub. Date: Feb. 13, 2003

(54) Process for the preparation and isolation of alkene oxides from alkenes

(76) Inventors: Gunter Schummer, Kerpen (DE); Christoph Zurlo, Leverkusen (DE); Helmut Woynar, Dormagen (DE); Markus Weisbeck, Koln (DE); Gerhard Wegener, Mettmann (DE); Kaspar Hallenberger, Leverkusen (DE)

Correspondence Address: BAYER CORPORATION, PATENT DEPARTMENT, 100 BAYER ROAD, PITTSBURGH, PA, 15205, US

(21) Appl. No.: 10/210,481

(22) Filed: Jul. 31, 2002

(30) Foreign Application Priority Data
Aug. 2, 2001 (DE) 10137826.2

(51) Int. Cl. C01B 3/26

(52) U.S. Cl. 423/651

(57) ABSTRACT

The invention provides a process for the catalytic partial oxidation of hydrocarbons, comprising passing a reaction mixture comprising the hydrocarbons, oxygen and at least one reducing agent through a layer which contains a catalyst, and then through a layer (located downstream of the catalyst-containing layer) which contains an aqueous absorption agent, in which the partially oxidized hydrocarbons are absorbed quantitatively.

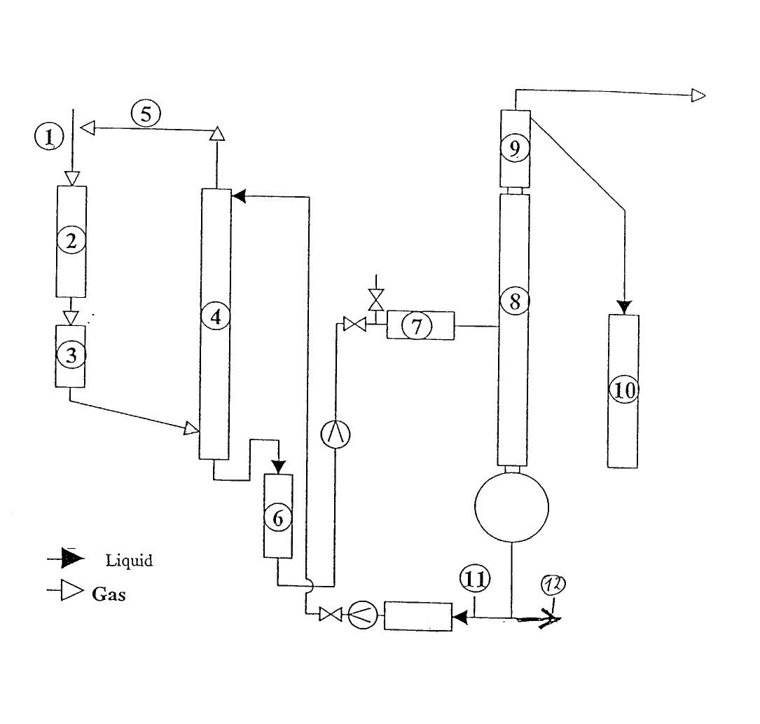

### BACKGROUND OF THE INVENTION

The present invention relates to a process for the catalytic partial oxidation of hydrocarbons in the presence of oxygen and at least one reducing agent. This process comprises passing the reaction through a layer which contains a catalyst, and then through a downstream layer which contains an aqueous absorption agent, in which the partially oxidised hydrocarbons are absorbed quantitatively.

The catalytic gas-phase partial oxidation of hydrocarbons in the presence of molecular oxygen and a reducing agent is known and described in, for example, DE-A1-199 59 525, DE-A1-100 23 717, U.S. Pat. No. 5,623,090, WO-98/00413-A1, WO-98/00415-A1, WO-98/00414-A1, WO-00/59632-A1, EP-A1-0827779, WO-99/43431-A1. Compositions which contain, inter alia, nanoscale gold particles, are used as catalysts therein.

Methods for the selective separation of the partial oxidation products from the reactants and secondary products produced by partial oxidation in the presence of reducing agents, as mentioned above, however, are not disclosed.

Methods for the purification of alkene oxides, such as adsorption, absorption, condensation etc., are known in principle.

To purify alkene oxides such as, for example, propene oxide, solid adsorption agents such as active carbon or zeolites, for example, may be used.

U.S. Pat. No. 4,692,535 discloses, for example, the separation of high molecular weight poly(propene oxide) from propene oxide by contact with active carbon.

U.S. Pat. No. 4,187,287, U.S. Pat. No. 5,352,807 and EP-A1 0 736 528 disclose the separation of various organic contaminants from alkene oxides, such as propene oxide and butene oxide, by treatment with solid active carbon.

The selective adsorption of the partial oxidation products of catalytic gas phase direct oxidation reactions with molecular oxygen and a reducing agent, however, is not described.

Likewise, the selective and quantitative separation of partial oxidation products of mixtures consisting of non-condensable gases such as hydrocarbons, oxygen, hydrogen, diluent gas and, on the other hand, water, water vapor, and, in particular, acidic secondary products such as, inter alia, carboxylic acids and/or aldehydes, is not described.

In commercial processes for the synthesis of ethylene oxide from ethene and molecular oxygen without the use of a reducing agent, the preferred process parameters include temperatures well above 200° C. and reaction pressures >15 bar. Ethene oxide, as the partial oxidation product, is produced with a selectivity of 80-85%. Almost exclusively, carbon dioxide and water are produced as virtually the only secondary products using the extreme process parameters with high temperatures and high pressures, due to the preferred total oxidation of ethene. The epoxide, together with carbon dioxide, is separated from the feed exclusively by absorption in water.

In the case of ethene direct oxidation, therefore, apart from the epoxide and carbon dioxide, hardly any other partially oxidized hydrocarbons such as, inter alia, aldehydes, ketones, acids, esters or ethers, which could permanently reduce the pH of the absorption water, are produced and thus greatly lower the stability of the epoxide in water.

The selective absorption of epoxides, such as propene oxide, arising from catalytic gas phase direct oxidation reactions with molecular oxygen and a reducing agent is not described.

On the other hand, partial oxidation with an oxygen/hydrogen mixture is performed in the temperature range from 140 to 210° C., which is thus, much lower than the temperature for partial oxidation described above where only oxygen and no additional reducing agent, such as hydrogen, is used.

The low reaction temperature of <<210° C. in the process using oxygen and a reducing agent means that virtually no total oxidation takes place, and therefore, only traces of carbon dioxide are formed. Instead of carbon dioxide, however, the product mixture contains, apart from an epoxide as the main product, many other partial oxidation products such as, for example, aldehydes, ketones, acids, esters, and ethers, in low concentrations. These secondary products can lower the pH in aqueous systems, and thus, reduce the stability of the epoxide (see Y. Pocker et al., J. Am. Chem. Soc., 1980, 102, 7725-7732: A Nuclear Magnetic Resonance Kinetic and Product Study of the Ring Opening of Propylene Oxide). Therefore, there is a bias towards thinking that absorption in water in the presence of acidic secondary products cannot be performed on an industrial scale.

Furthermore, all published applications for the selective oxidation of hydrocarbons in the presence of oxygen and a reducing agent achieve only a small hydrocarbon conversion of less than 10%. All the processes are performed, on an industrial scale, with very large amounts of circulating gas. The isolation of very small volumes of useful products (e.g. 2 vol. % of hydrocarbon oxide) from large amounts of gas (e.g. 98 vol. % of gas consisting of hydrocarbon, hydrogen, oxygen, water, acetaldehyde, propionaldehyde, acetone, acetic acid, formaldehyde, etc.) is very costly. Therefore, the economic viability of the selective oxidation processes described is determined critically on the costs of useful product isolation.

### SUMMARY OF THE INVENTION

The object of the present invention is to provide a process for the continuous synthesis of epoxides by partial catalytic gas phase oxidation of hydrocarbons in the presence of oxygen and a reducing agent, with subsequent continuous quantitative isolation of the partial oxidation product by ab(de)sorption in/from water.

Another object of the present invention is to provide a process in which a high total conversion of alkene is achieved.

Another object of the present invention is to provide a process in which the partially oxidized hydrocarbon can be isolated as quantitatively and as continuously as possible.

According to the present invention, this object is achieved by a process for the catalytic partial oxidation of hydrocarbons which comprises (a) passing a reaction mixture through a layer which contains a catalyst, wherein the reaction mixture comprises one or more hydrocarbons, oxygen, and at least one reducing agent, and absorbing the partially oxidized hydrocarbons in an absorption layer which contains water and is located downstream of the layer containing the catalyst.

### BRIEF DESCRIPTION OF THE FIGURE

The FIGURE is a flow diagram illustrating the overall process for the partial oxidation of a hydrocarbon such as, for example, propylene, to a hydrocarbon oxide such as, for example, propylene oxide in accordance with the present invention.

### DETAILED DESCRIPTION OF THE INVENTION

The term hydrocarbon, as used herein, is understood to mean unsaturated or saturated hydrocarbons such as, for example, olefins or alkanes, which may also contain heteroatoms such as N, O, P, S or halogen atoms. The organic component to be oxidized may be acyclic, monocyclic, bicyclic or polycyclic, and may be monoolefinic, diolefinic or polyolefinic.

In the case of hydrocarbons with two or more double bonds, the double bonds may be conjugated or non-conjugated. The hydrocarbons from which the oxidation products are preferably formed are those hydrocarbons that yield oxidation products whose partial pressure is sufficiently low so as to enable removal of the product from the catalyst continuously. It is preferred to use unsaturated and saturated hydrocarbons with 2 to 20, preferably 2 to 12 carbon atoms, and most preferably include compounds such as, for example, ethene, ethane, propene, propane, isobutane, isobutylene, 1-butene, 2-butene, cis-2-butene, trans-2-butene, 1,3-butadiene, pentenes, pentane, 1-hexene, hexenes, hexane, hexadiene, cyclohexene, benzene.

The oxygen can be used in a wide variety of forms. For example, oxygen suitable for the present invention can be present in the form of molecular oxygen, air, and/or nitrogen oxide. Molecular oxygen is preferred.

Hydrogen in particular is suitable compound to be used as a reducing agent in the present invention. Any known source of hydrogen can be used such as, for example, pure hydrogen, cracker hydrogen, synthesis gas, or hydrogen from the dehydrogenation of hydrocarbons and alcohols. In another embodiment of the invention, hydrogen may also be produced in situ in an upstream reactor by, for example, the dehydrogenation of propane or isobutane, or alcohols such as isobutanol. The hydrogen may also be introduced into the reaction system as a complex-bonded species such as, for example, a catalyst/hydrogen complex.

A diluent gas may also be optionally included in the reaction mixture in addition to the essential reactant gases described above. Examples of suitable diluent gases include compounds such as nitrogen, helium, argon, methane, carbon dioxide, carbon monoxide, or similar gases which are predominantly gases. It is also possible to use mixtures of the described inert components. The addition of the inert component is often beneficial with regard to transport of the heat which is released in this exothermic oxidation reaction and from a safety point of view. If the process according to the invention is performed in the gas phase, gaseous diluent components such as, for example, nitrogen, helium, argon, methane and possibly water vapor and carbon dioxide are preferably used. Although water vapor and carbon dioxide are not completely inert, they often have a positive effect at low concentrations (<2 vol. % of total reaction gas composition).

The relative molar ratios of hydrocarbon, oxygen, reducing agent (in particular, hydrogen), and optionally, a diluent gas can be varied between wide limits.

Oxygen is preferably present in the range of from 1 to 30 mol % of feed or Cycle gas composition, and more preferably of from 5 to 25 mol %.

An excess of hydrocarbon, with respect to the oxygen used (on a molar basis), is preferably used. The hydrocarbon concentration is typically greater than 1 mol % and less than 96 mol %. Hydrocarbon concentrations in the range of preferably of from 5 to 90 mol %, more preferably of from 20 to 85 mol % are used. The molar proportion or amount of reducing agent (in particular, the proportion of hydrogen), with respect to the total number of moles of hydrocarbon, oxygen, reducing agent and diluent gas, can be varied between wide limits. Typical reducing agent concentrations are greater than 0.1 mol %, preferably from 2 to 80 mol %, and more preferably from 3 to 70 mol %.

Compositions which contain noble metal particles with a diameter of less than 51 nm on a support material which contains metal oxide and silicon oxide, are advantageously and preferably used as catalysts in the present invention.

Gold and/or silver are preferably used as noble metal particles. The gold particles preferably have a diameter in the range of from 0.3 to 10 nm, preferably of from 0.9 to 9 nm, and particularly preferably of from 1.0 to 8 nm. The silver particles preferably have a diameter in the range of from 0.5 to 50 nm, preferably of from 0.5 to 20 nm and particularly preferably of from 0.5 to 15 nm.

As catalyst support materials, it is preferred to use the hybrid support materials described in, for example, DE-A1-199 59 525 and DE-A1-100 23 717, the disclosures of which are herein incorporated by reference

Organic-inorganic hybrid materials within the scope of the present invention are typically organically modified glasses, which are preferably produced in a sol-gel process via the hydrolysis and condensation reactions of soluble precursor compounds and contain non-hydrolysable terminal and/or bridging organic groups in the network. Such materials and their preparation are disclosed, inter alia, in DE-A1-199 59 525, DE-A1-100 23 717, the disclosures of which are herein incorporated by reference.

The generation of gold particles on the support materials is generally in accordance with the processes described in, for example, U.S. Pat. No. 5,623,090, WO-98/00413-A1, WO-98/00415-A1, WO-98/00414-A1, WO-00/59632-A1, EP-A1-0827779 and WO-99/43431-A1, the disclosures of which are herein incorporated by reference. Suitable processes include those such as, for example, deposition-precipitation, co-precipitation, impregnation in a solution, incipient wetness, colloid processes, sputtering, CVD (Chemical Vapor Deposition), PVD (Physical Vapor Deposition) and microemulsion.

The methods of incipient wetness, solvent impregnation, and a combination of impregnating the support materials with noble metal precursors and then immediately drying by a spray or fluidised bed techniques are described in, for example, DE-A1-199 59 525, DE-A1-100 23 717, the disclosures of which are herein incorporated by reference. These methods are particularly advantageous.

The support materials may also contain, as promoters, proportions of metals from group 5 of the Periodic System according to IUPAC (1985) such as vanadium, niobium, and tantalum, from group 3, preferably yttrium, from group 4, preferably zirconium, from group 8, preferably Fe, from group 15, preferably antimony, from group 13, preferably aluminium, boron, thallium and metals from group 14, preferably germanium, and from groups 1 and 2, preferably sodium and/or cesium and/or magnesium and/or calcium. The additional metals (promoters) are frequently present in the form of oxides.

The noble metal-containing compositions according to the present invention can be used at temperatures >10° C., preferably in the range of from 80 to 230° C., and more preferably in the range of from 120 to 210° C. At the higher temperatures, steam, as an energy carrier, may be produced in a coupled plant. With skillful process management, the steam can be used, for example, to work up the product.

The oxidation reaction is advantageously performed at elevated reaction pressures. Reaction pressures of >1 bar, particularly preferably 2-30 bar are preferred.

The catalyst loading can be varied between wide limits. Catalyst loadings of from 0.5 to 100 liters of gas (feed or cycle gas) per ml of catalyst per hour are preferably used, and catalyst loadings of from 2 to 50 liters of gas per ml of catalyst per hour are most preferably used.

In the catalytic oxidation of hydrocarbons in the presence of hydrogen, water is generally produced as a product coupled with the corresponding selective oxidation product.

Surprisingly, it is possible to continuously separate the partial oxidation products produced in the direct oxidation in the presence of oxygen and a reducing agent from the reaction mixture, even in the presence of acidic secondary products, by selective absorption in water without decomposition or the production of further products of these absorption products.

Water is used as the preferred absorption agent in accordance with the present invention.

In some cases, the absorption agent may also contain additives which, for example, increase the solubility of the partially oxidized hydrocarbon (i.e. solution promoters), or inhibit further reaction of the partial oxidation products with water, possibly catalyzed by acidic or basic secondary products (i.e. stabilizers).

Suitable additives to perform the function of “solution promoter” include, inter alia, functionalized hydrocarbons such as, for example, lower alcohols, ketones and ethers.

Suitable additives to perform the function of “stabilizers” include, for example, bases, acids, buffer systems and/or salts. In some cases, increasing the pH to, for example, a constant 7-9 results in a clear increase in stability of the epoxide in aqueous medium in the presence of reaction-typical secondary products such as aldehydes and/or carboxylic acids.

Hydrocarbon oxide absorption in water is favored by increasing pressures and/or decreasing temperatures, and reduced by heating and/or lowering the pressure.

Hydrocarbon oxide absorption preferably takes place at the reaction pressure (for example at pressures of from 5 to 30 bar). Subsequent hydrocarbon oxide desorption then preferably takes place under reduced pressure. For economic reasons, a compromise has to be made between easier hydrocarbon oxide desorption at low pressures and the costs of subsequent gas compression. A pressure difference between absorption and desorption of ≦30 bar, and more preferably <25 bar, is used.

A flow chart of one embodiment for the overall process in accordance with the present invention is illustrated in the FIGURE. In the FIGURE, the partial oxidation of propylene to propylene oxide in the presence of oxygen and hydrogen with continuous ab(de)sorption in/from water is illustrated.

In the FIGURE, the feed streams 1 which form the reaction mixture are fed to the reactor 2, passed to a heat-exchanger 3, then to the absorber (i.e. absorption column) 4. In close proximity to the absorber 4 is a blower 5 which recycles the gas stream which has been depleted of partial oxidation products by the absorber 4. Upon leaving the absorber 4, the water or other aqueous medium enriched with propylene oxide enters a reservoir 6 which serves as an expansion vessel for the system while the contents of the reservoir are being pumped through a heat-exchanger 7 and into a desorber (i.e. desorption column) 8. The enrichment section 9 where concentration of the propylene oxide occurs is located above the desorber 8. From the enrichment section 9, the propylene oxide passes to a storage tank 10. Fresh water and/or the secondary products 11 are removed from the desorber 8 and circulated back to the absorber 4. Waste water leaves at gate 12.

During the catalytic partial oxidation of, for example, propylene with an oxygen/hydrogen mixture, a reaction mixture is obtained which consists of, for example, 1.5 vol. % of propylene oxide, 0.1 vol. % propionaldehyde, 0.1 vol. % acetaldehyde, 0.1 vol. % acetone, 0.02 vol. % acetic acid and 0.05 vol. % propylene glycol. The propylene oxide can be virtually quantitatively and continuously isolated in accordance with the FIGURE.

The organic partial oxidation products in the reaction gas stream are absorbed quantitatively in water. The entire reaction gas stream, at the reaction pressure, is advantageously passed from the bottom through an absorber column with a large number of plates, while water runs in counterflow from top to bottom.

The gas stream which has been depleted of the partial oxidation products is preferably recycled to the reactor for repeated reaction by, for example, a blower or other suitable means, and optionally, after further purification by, for example, drying. This gas stream consists substantially of unreacted hydrocarbons, reducing agent, oxygen, and optionally, a diluent gas. When using a blower with moving parts, it must be realized that there is always, in principle, a slightly increased risk of explosion. The risk of explosion in the compressor could, in some cases, be reduced by adding small amounts of water vapor.

Substantially increased total conversions can be achieved by using this circulating mode of operation with regular separation of the reaction products. Concentrating the reaction products by absorption in water greatly lowers the processing costs for isolation of the hydrocarbon.

The absorption column is advantageously operated in counterflow, i.e. the reaction gas mixture flows from the bottom to the top of the column and the water flows in counterflow from the top to the bottom of the column. This counterflow absorption process takes place continuously and preferably at the reaction pressure. A mode of operation in which the absorber pressure is from 3 to 20 bar and the absorption temperature is from 15 to 50° C. is particularly preferred. As a cooling medium cooling water or brine is used at, for example, a temperature of 20° C. in counterflow to the process medium.

The water enriched with the propylene oxide and other partial oxidation products then passes into, for example, a reservoir which is under the reaction pressure and which acts as a expansion vessel for a pump which feeds the contents of the reservoir against a pressure retainer into a region in which the system pressure (0.5-10 bar) is lower than in the reactor and absorber. Here, the low-boiling components such as propylene oxide, acetaldehyde, propionaldehyde and acetone, partly desorb. The desorption process is preferably increased still further by heating the laden water mixture in a heat-exchanger. Here, temperatures of 60 to 150° C. are suitable. Concentration of the propylene oxide takes place, in many cases, directly in the enrichment section above the desorber column.

Isolation of the propylene oxide from other highly-volatile partial oxidation products generally takes place in a downstream precision distillation section.

The heat of reaction produced during partial oxidation is advantageously used in the plant section Desorption, for example, when operating the reactor as a circulation evaporator for the desorption column.

In accordance with the present invention, it is particularly preferred to oxidize propylene to propylene oxide.

The characteristic properties of the present invention are explained in the following examples using test reactions.

The following examples further illustrate details for the process of this invention. The invention, which is set forth in the foregoing disclosure, is not to be limited either in spirit or scope by these examples. Those skilled in the art will readily understand that known variations of the conditions of the following procedures can be used. Unless otherwise noted, all temperatures are degrees Celsius and all percentages are percentages by weight.

### EXAMPLES

Procedure used in the test for continuous absorption of catalytically prepared crude propylene oxide and secondary products in water with subsequent desorption (test procedure):

A metal tubular reactor having an internal diameter of 15 mm and a length of 100 cm was used, and the temperature was kept constant with an oil thermostat. The reactor was supplied with a set of four mass flow regulators (hydrocarbon, oxygen, hydrogen, nitrogen) for the reactant gases. A gas stream for performing oxidation reactions, always referred to as the standard gas composition in the following description, was chosen: it comprised H₂/O₂/C₃H₆:60/10/30 vol. %.

For reaction, 60 g of molded items with an active substance content of 20% (2×2 mm extrudates) were initially introduced at 165° C. and 3 bar. The active substance loading was 10 liters gas/(g active substance×h). Propylene, for example, was used as a hydrocarbon. The catalyst productivity, when using propylene as the hydrocarbon, was 400 g propylene oxide/(kg active substance×h). The reaction gas stream was then cooled to 35° C. using a heat-exchanger and passed into a downstream counterflow absorber (i.e. a metal tube which had an internal diameter of 20 mm and was 100 cm in length; filled with 3×3 netting wire rings) under the system pressure. Water (800 g/h) flowed from top to bottom against the gas stream. The water laden with organics passed into an expansion reservoir. From there the mixture passed into a heat-exchanger, was heated there to 95° C. and the pressure was decreased to atmospheric pressure, downstream of a pressure retention valve, in the desorber held at 100° C. (which has an internal diameter of 20 mm; was 100 cm in length; and filled with 3×3 netting wire rings).

The reflux ratio was, for example, 5-20. The low-boiling fraction consisting of, inter alia, propylene oxide, propionaldehyde, acetone, acetaldehyde, passed to the head of the column, condensed and was condensed in the storage vessel cooled to 5° C.

The reaction gases were analyzed by gas chromatography (GC) downstream of the reactor (Sample 1) and above the absorber head (Sample 2) (a combined FID/WLD method, in which the gas passed through three capillary columns). The water laden with organics was analyzed upstream of the reservoir (Sample 3) and at the base of the desorption column (Sample 4), using gas chromatography (FID; FFAP column). The contents of the cooled storage vessel were also analyzed using gas chromatography with FID (Sample 5). FID is flame ionization detector; WLD is heat conductivity detector.

Catalyst Preparation:

This example describes, firstly, the preparation of a powdered catalytically active organic-inorganic hybrid material consisting of a silicon and titanium-containing organic-inorganic hybrid material with free silane hydrogen units which were coated with gold particles (0.04 wt. %) using the incipient wetness method. Then, the finely powdered catalyst material was converted into an extrudate.

184.29 g of methyltrimethoxysilane (1.35 mol) and 25.24 g of triethoxysilane (153.6 mmol) were initially introduced. To this, 44.79 g of p-toluenesulfonic acid (0.1 N) were added, and then 17.14 g of tetrapropoxytitanium, dissolved in 40 g of ethanol, were also added. After an ageing period of 12 h, the gel was washed twice using 200 ml of hexane each time, and then dried for 2 h at RT and for 8 hours at 120° C. in air.

10.1 g of dried sol-gel material were impregnated with 5 g of a 0.16% strength solution of HAuCl₄×H₂O in methanol, with stirring (incipient wetness), dried at RT in a stream of air, then for 8 h at 120° C. under air and then conditioned for 5 h at 400° C. under an atmosphere of nitrogen. The catalytically active organic-inorganic hybrid material prepared in this way contained 0.04 wt. % of gold.

Formation of an Extrudate:

8.5 g of organic-inorganic hybrid material, synthesised in accordance with the catalyst preparation described above, were intensively mixed with 5 g of silicon dioxide sol (Levasil, Bayer, 300 m²/g, 30 wt. % SiO₂ in water) and 1.0 g of SiO₂ powder (Ultrasil VN3, Degussa) for 2 h. 2 g of sodium silicate solution (Aldrich) were added to the plastic material obtained, the mixture was intensively homogenised for 5 min and then molded in an extruder to form 2 mm strands. The strands prepared in this way were first dried for 8 h at room temperature, then for 5 h at 120° C., and finally conditioned at 400° C. for 4 h under an atmosphere of nitrogen. The mechanically stable molded items had a high resistance to lateral pressure.

The conditioned 2×2 mm molded items were used as a catalyst in the gas phase epoxidation of propylene with molecular oxygen in the presence of hydrogen.

### Example 1

The total reaction gas composition (feed after reaction); (analysis at reactor outlet; before the adsorber; sample 1) contained 1.5 vol. % propylene oxide, 2.5 vol. % water and 0.05 vol. % secondary products (including acetaldehyde, propionaldehyde, acetone, acetic acid) at the reactor outlet. The reaction gas was passed, at the reaction pressure (3 bar), from below into a counterflow absorber which was completely filled with netting wire rings (3×3 mm). The pressure of the non-absorbed gas was allowed to return to atmospheric pressure at the head of the absorber and was analyzed by gas chromatography. The concentrations of propylene oxide and the partial oxidation products produced as secondary products were below the limits of detection at this point. The absorption process for the condensable organic compounds proceeded virtually quantitatively.

The water laden with partial oxidation products was heated to 95° C. in a heat-exchanger and decompressed into the desorption column (the desorption column had a temperature of 100° C. at the lateral entry point). With a reflux ratio of 1:10, a temperature of 45° C. was produced at the head of the column. The container, cooled to 5° C., contained 70 vol.-% organic compounds and 30 vol.-% water. The organic compounds, for their part, consisted of >94 vol.-% propylene oxide, 2 vol.-% propionaldehyde, 1 vol.-% acetaldehyde and traces of acetone and butanedione. The base of the column contained no propylene oxide or acetaldehyde or propionaldehyde. Only traces of glycol were detectable.

Overall, >95 vol.-% of the propylene oxide found in the reaction gas could be isolated in a single pass.

### Example 2

Example 2 was similar to example 1, but the reflux ratio in the desorption column was 1:15.

With a reflux ratio of 1:15, a temperature of 40° C. was produced at the head of the column. The container, cooled to 5° C., contained 78 vol.-% organic compounds and 22 vol.-% water. The organic compounds, for their part, consisted of 94 vol.-% propylene oxide, 2 vol.-% propionaldehyde, 1 vol.-% acetaldehyde and traces of acetone and butanedione. The base of the column contained no propylene oxide, acetaldehyde, or propionaldehyde. Only traces of glycol and carboxylic acids were detectable.

Overall, 94 vol.-% of the propylene oxide found in the reaction gas could be isolated in a single pass.

### Example 3

Example 3 proceeded in the same way as Example 1, but the system pressure for reactor and absorber was 5 bar.

With a reflux ratio of 1:10, a temperature of 37° C. was produced at the head of the desorber column. The container, cooled to 5° C., contained 90 vol.-% organic compounds and 10 vol.-% water. The organic compounds, for their part, consist of 92 vol.-% propylene oxide, 2 vol.-% propionaldehyde, 1.1 vol.-% acetaldehyde and traces of acetone and butanedione. The base of the column contained no propylene oxide or acetaldehyde or propionaldehyde. Only traces of glycol and carboxylic acids were detectable.

Overall, 93 vol.-% of the propene oxide found in the reaction gas could be isolated in a single pass.

### Example 4

Example 4 proceeded in the same way as Example 1, but the unreacted feed gas, after the absorber, was returned to the reactor using a blower.

The reaction gas, after passage through the absorber, downstream of the head of the desorber, had the following composition by volume: 58% H₂, 8.5% O₂, 27.5% C₃H₆, 0.2% water, 0.005% propylene oxide, and 0.001% acetaldehyde. This gas was returned to the reactor using a blower.

The reaction gas (analysis at the reactor outlet; before the absorber; Sample 1) contained 1.4 vol. % propylene oxide, 2.1 vol. % water and 0.05 vol. % secondary products (including acetaldehyde, propionaldehyde, acetone, acetic acid) at the reactor outlet.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for the catalytic partial oxidation of hydrocarbons comprising:
(a) passing a reaction mixture through a catalyst-containing layer, wherein the reaction mixture comprising (1) one or more hydrocarbons, (2) oxygen, and (3) at least one reducing agent, and
(b) absorbing the partially oxidized hydrocarbon in a layer located downstream of the catalyst-containing layer, wherein said layer contains an aqueous absorption agent which quantitatively absorbs the partially oxidized hydrocarbon.

2. The process of claim 1, additionally comprising:
(c) recycling the reaction gas back into (a) for reaction with the catalyst-containing layer, after absorption of the partially oxidized hydrocarbons in (b).

3. The process of claim 1, wherein (b) the absorption of the partially oxidized hydrocarbon is carried out in the presence of non-condensable gases.

4. The process of claim 3, wherein the non-condensable gases are selected from the group consisting of oxygen, hydrogen, and mixtures thereof.

5. The process of claim 1, wherein the heat formed in (a) the partial oxidation of the hydrocarbon, is used integrally during the working up procedure consisting, inter alia, of absorption in water and desorption from water.

6. The process of claim 1, wherein said absorption agent comprises water.

7. The process of claim 5, wherein the pH of the water is held constant in the range 4-9 by the addition of bases and/or buffer systems.

8. The process of claim 1, wherein the absorbed partial oxidation products are separated into lights and heavies by a desorption column.

9. The process of claim 1, wherein the desorption occurs with partial pressure release and elevated temperatures in the range 70-150° C.
